(19) United States
(12) Patent Application Publication
(10) Pub. No.: US 2008/0248706 A1
(43) Pub. Date: Oct. 9, 2008

(54) Artists panel with watercolor releasable coating

(76) Inventor: James R. January, Sugar Hill, GA (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/109,062

(22) Filed: Apr. 24, 2008

Related U.S. Application Data
(63) Continuation-in-part of application No. 10/706,427, filed on Nov. 12, 2003.

(51) Int. Cl. B32B 9/04

(52) U.S. Cl. 442/153; 428/411.1; 428/500

(57) ABSTRACT

An artists canvas suitable for accepting and releasing water-based paints, pencils, and inks, in which the artists canvas is coated with a coating is formulated to accept and release water-based paints, pencils, and inks without unacceptable running or bleeding of the water-based paints, pencils, and inks in and on the coating.

### STATEMENT OF RELATED APPLICATIONS

This application is a continuation-in-part of U.S. patent application Ser. No. 10/706,427 entitled “Watercolor Canvas” and having a filing date of 12 Nov. 2003, currently pending.

### BACKGROUND OF THE INVENTION

1. Technical Field

The present invention is generally in the field of artists panels that are coated so as to allow the panel to be used as a medium for accepting watercolor paints and more specifically in the field of artists canvases having releasable coatings that allow watercolors to be applied to and released from the artists panel without damaging the artists canvas or the coating.

2. Prior Art

Historically, watercolor and related methods of painting have primarily used paper as a medium. There have been coatings produced that could be applied to rigid surfaces to make these substrates accept watercolors. However, papers must be handled with great care, and rigid substrates can quickly become cumbersome to handle owing to their weight and bulk. To the inventor's knowledge and belief, no one has successfully produced a coated canvas material that could be used for watercolor painting or drawing techniques. A coated canvas would allow for much greater latitude in options for mounting in preparation for painting. Unlike papers and rigid substrates, canvas can be stretched. And unlike rigid substrates, canvas can be rolled up for transport as well as being much lighter in weight.

Currently, artist canvas is almost exclusively coated with one of two types of priming material: water-based latexes or oil-based paints. There currently are no commercially successful coated canvases that are sold especially for the purpose of watercolor painting. Neither the latex- or oil-based priming materials have properties that properly allow for watercolor painting. The surfaces of latex- and oil-based priming materials tend to be hydrophobic and repel water rather than absorb it as would be necessary for watercolor techniques.

There are coatings and related systems related to inkjet printing with water-based inks. However, in most cases, these systems are unsuitable for watercolor techniques because of physical or performance limitations. In many cases, these systems simply are not able to tolerate the large amount of water involved in watercolor techniques. These systems either are damages by the water or cannot absorb enough water to allow for the practical application of watercolors.

U.S. Pat. No. 3,853,579 to Heiser discloses a coating containing a plastic polymeric pigment for applying to a paper substrate. The coating is both for opacifying the paper and for providing an improved writing surface. The coating comprises discrete, substantially spheroid, plastic, polymeric particle pigment having an average diameter in the 0.3 to 0.8 micron range. Interestingly, the patent claims require printing applied to the coating, which would appear to indicate that the specific formula for the coating may not be overly unique, only the combination with printing. In any event, this is a paper coating and is not for allowing one to watercolor on canvas.

Several of the known but unsuitable inventions include the following coating and printing techniques.

U.S. Pat. No. 4,065,596 to Groody discloses an artist's board comprising a rigid backer, a front paintable member and an intermediate resilient member that allows the front member to flex so that the entire board has the feel of canvas alone. U.S. Pat. No. 4,562,107 to Daniels discloses coating textile fabrics with a curable polymer binder, an opacifier, and a pigment to obtain washfast, opaque printed areas that are substantially unaffected by the base color of the fabric. U.S. Pat. No. 5,167,704 to Brower discloses a soy based ink meant to simulate watercolor without the disadvantage of watercolors. U.S. Pat. No. 5,700,522 to Nonweiler discloses aqueous emulsion-based coating compositions with a latex binder whose primary use is for coating hard substances, such as polymers and metals.

U.S. Pat. No. 5,700,858 to Deir discloses a plastisol paint that requires heat curing to harden. U.S. Pat. No. 6,051,059 to Aisner discloses a liquid art medium for creating three-dimensional art and contains an acrylic polymer. U.S. Pat. Nos. 6,258,412 and 6,423,379 to Ewing disclose a method of making an artistic medium that is mineral based in an acrylic polymer binder. U.S. Pat. Nos. 6,403,673 and 6,410,363 to Groves disclose water dispersed photoreactive primers for improving adhesion to substrates. U.S. Pat. Nos. 6,663,143 and 7,182,828 to Zirker disclose acrylic paint monotype artwork and are for a method for producing artwork using acrylic paints and gels.

Plain untreated or uncoated canvas absorbs water and therefore when watercolor is applied to plain canvas, the colors bleed. The prior art coatings and systems do not allow for the coating of a stretchable and flexible canvas or similar material that will accept watercolor painting media. So, for this reason, people do not watercolor on canvas. Accordingly, there is a need for a coated canvas that will releasably accept watercolor media. The present invention is directed to his need and other needs as disclosed in this specification.

### BRIEF SUMMARY OF THE INVENTION

The present invention is an artists panel comprising a flexible coated material that can be used as a medium for watercolor and related techniques and methods. The present invention covers both woven and non-woven materials comprising a coating formulated to properly accept watercolor paints, watercolor pencils, acrylic paints and water-based inks. Thus, the present invention is a multi-purpose artists panel for use with all of the major watercoloring media and that is especially useful for watercolors due to its releasable characteristic.

Canvas is the preferred panel substrate because of its common use by artists for acrylic and oil paintings, and its desired visible texture that has become known and desired by artists and viewers alike. Although a wide variety of natural and synthetic materials can be used to weave the canvas, the preferred embodiment uses natural fibers such as cotton and linen, which have a greater affinity for moisture, thus making them a preferred base for the large amounts of water that are a part of these watercolor techniques.

The coatings comprise water-based latexes such as latexes based on acrylic and vinyl polymers, and combinations thereof, with acrylic latexes being preferred owing to their demonstrated utility and durability as a medium for artist applications. The coatings also comprise materials to provide the wetting and absorption of water by the latexes. An illustrative formulation for an exemplary coating comprises acrylic latex, pigment, defoamer, calcium carbonate, talc, surfactant, polyvinyl alcohol, and water.

The present invention is a coated or primed substrate, such as a canvas, suitable as a support or medium for watercolor painting using watercolor (water-based) paints, pencils, and inks. Watercolor techniques are distinguished from other painting techniques by their very fluid nature, employing large amounts of water before, during, and/or after application of the colors. Thus, the present invention can absorb, retain, and eventually release all of the water, and can provide a range of “control” to allow the artist to create the desired amount of “flow” of the colors. Thus, hydrophobic acrylic and other polymeric emulsions are not generally suitable for the coating as emulsions typically form hydrophobic films and so tend to repel water.

Water-soluble film formers of both natural and synthetic derivation allow and provide absorption of water into the film body, but the water also tends to re-dissolve the film. Polyvinyl alcohol, polyvinyl pyrrolidine, gums, starches, and similar polymers fall into this category. Cotton and other natural fiber woven canvases are efficient at absorbing water by both their hydrophilic nature as well as via capillary action. However, natural fiber woven canvases generally are not acceptable as support for watercolor techniques due to the background pattern of the canvas weave that is “developed” by the colors.

The present invention achieves an acceptable result by the inclusion of water-soluble film formers into a typical latex-based coating, which is then applied to a canvas base to form the support. If there is too little water-soluble polymer, then the surface can remain too repellant for watercolor techniques. If there is too much water-soluble polymer, then the coating can lose its integrity when large amounts of water typical of watercolor techniques are applied. This ratio also is important to optimize the quality of removing (“lifting”) the colors from the surface in order to create special effects typical of watercolor techniques.

Many illustrative features, objects and advantages of the present invention will become more apparent to those of ordinary skill in the relevant art when the following detailed description of the preferred embodiments is read in conjunction with the appended drawings in which like reference numerals represent like components throughout the several views.

### BRIEF DESCRIPTION OF THE DRAWINGS

FIG. 1 is a side sectional view of an exemplary coated woven substrate.

FIG. 2 is a side sectional view of an exemplary coated non-woven substrate.

### DETAILED DESCRIPTION OF THE PREFERRED EMBODIMENTS

The present invention is a coated material that can be used as a medium for watercolor and related techniques and methods. The present invention covers both woven and non-woven substrate materials comprising a coating formulated to properly accept watercolor paints, watercolor pencils, acrylic paints and water-based inks. While both woven and non-woven substrate materials are suitable for this invention, the preferred embodiment uses a woven substrate material such as canvas because of its likeness to those canvases used by artists for acrylic and oil paintings. And while a wide variety of natural and synthetic materials can be used to weave the canvas, the preferred embodiment uses a material made with natural fibers such as cotton and linen. Natural fibers have a greater affinity for moisture making them a preferred base for the large amounts of water that are a part of these painting techniques.

The coatings disclosed for this invention comprise water-based latexes commonly used to prepare artists canvas for the more traditional painting methods utilizing acrylic or oil paints. Latexes based on acrylic and vinyl polymers, as well as combinations of acrylic and vinyl polymers, are part of this invention. Acrylic latexes are preferred owing to their demonstrated utility and durability as a medium for artist applications.

The coatings for this invention incorporate materials to provide the wetting and absorption of water by the latexes. The amount of these materials necessary, however, is unexpectedly low so that the basic physical properties of the coating are not substantially compromised. This allows the finished article, namely the canvas, to be scrubbed to repair or remove a mistake or other undesirable features in a painting without harming the coating.

Preferred embodiments of the coatings comprise the components shown in Table 1.

TABLE 1
COATING COMPONENTS

| Component | Preferred Range (parts by weight) |
|---|---|
| Water-based latex | 100-200 |
| Pigment dispersant | 0-5 |
| Defoamer | 0-2 |
| Pigments and Colorants | 75-150 |
| Extenders | 0-50 |
| Surfactant | 0-5 |
| Water | 10-50 |

After dispersing the pigment dispersant, defoamer, pigments, colorants, extenders, and surfactant in the latex and water to create a paint mixture, the paint mixture is mixed with a water soluble polymer to create the coating mixture. Generally, the water soluble polymer is first is dispersed in additional water, and the water soluble polymer and water mixture is added to the paint mixture, as the water soluble polymer and water mixture is hydrophilic. Preferably from 5 to 20 parts by weight of water soluble polymer is mixed with from 80 to 95 parts by weight of water. The inclusion of a water soluble polymer is to allow for the proper absorption of water by the coating and canvas.

The water soluble polymer can be added to the paint mixture at ratios of 1 to 30 weight percent based on the weight of the solids in the paint. For example, if a paint formula was 60 weight percent solids, there would be 0.6 to 18 parts of water soluble polymer for each 100 parts of paint mixture (60 parts of paint solids). The preferred ratio would be 2 to 10 weight percent of the water soluble polymer.

The coating mixture then is coated onto the substrate, allowed to dry or is dried, and the resulting coated substrate is suitable for accepting watercolors. The resulting coated substrate then can be stretched over stretcher strips to form an artists panel, as is known in the art. As is also known in the art, the stretcher strips can form an internal frame to support and shape the coated substrate so as to present the coated substrate in a form more suitable for painting and framing.

The latex base can be selected from the group consisting of but not limited to acrylic latexes, vinyl latexes, polyvinyl latexes, other common and known water-based latexes, and mixtures thereof.

The pigment dispersant can be selected from the group consisting of but not limited to known, common, and future developed pigment dispersants suitable in the coating field in general and the paint-related coating field in general.

The defoamer can be selected from the group consisting of but not limited to known, common, and future developed defoamers suitable in the coating field in general and the paint-related coating field in general.

The pigments and colorants can be selected from the group consisting of but not limited to titanium dioxide, calcium carbonate, magnesium carbonate, magnesium silicate, clay, inorganic colors, barium sulfate, mica, zinc oxide, zinc dust, metallics, organic colors, silica, other silicates, aluminates, sulphates, carbonates, other common and known pigments and colorants, and mixtures thereof.

The extender can be selected from the group consisting of but not limited to china clay, kaolin clay, talc, silica, whiting, metal stearates, gypsum, mica, barite, blanc fixe, other common and known extenders, and mixtures thereof.

The surfactant can be selected from the group consisting of but not limited to known, common, and future developed surfactants suitable in the coating field in general and the paint-related coating field in general.

The water soluble polymer can be selected from the group consisting of but not limited to polyvinyl alcohol, polyethylene oxide, cellulose and its derivatives, polyvinyl pyrrolidone, starch, animal hide glue, gum arabic, xanthan gum and guar gum.

A typical illustrative formulation for the coating is shown in Table 2.

TABLE 2
ILLUSTRATIVE COATINGS

| | Preferred Range (parts | Illustrative Formula 1 |
|---|---|---|
| Component | by weight) | (parts by weight) |
| Acrylic latex | 100-200 | 150 |
| Pigment dispersant | 0-5 | 2 |
| Defoamer | 0-2 | 0.8 |
| Calcium carbonate | 75-150 | 115 |
| Talc | 0-50 | 20 |
| Surfactant | 0-5 | 2 |
| Water | 10-50 | 30 |

As above, after dispersing the pigment dispersant, defoamer, calcium carbonate, talc, and surfactant in the latex and water to create a paint mixture, the paint mixture is mixed with a water soluble polymer such as polyvinyl alcohol and water mixture to create the coating mixture. In this example, 12 parts by weight of polyvinyl alcohol is mixed with 88 parts by weight of water to form the polyvinyl alcohol and water mixture.

Additional illustrative formulations for the coating are shown in Table 3.

TABLE 3
Additional Illustrative Coatings

| | Illustrative Formula 2 | Illustrative Formula 3 |
|---|---|---|
| Component | (parts by weight) | (parts by weight) |
| Acrylic latex | 140 | 150 |
| Pigment dispersant | 2 | 2 |
| Defoamer | 0.8 | 0.8 |
| Calcium carbonate | 95 | 0 |
| Kaolin clay | 0 | 100 |
| Titanium dioxide | 18 | 20 |
| Talc | 14 | 0 |
| Surfactant | 1 | 2 |
| Water | 30 | 30 |

As above, after dispersing the pigment dispersant, defoamer, calcium carbonate or kaolin clay, titanium dioxide, talc if used, and surfactant in the latex and water to create a paint mixture, the paint mixture of Illustrative Formula 2 is mixed with a water soluble polymer such as 100 parts by weight of Vivprint 540 brand water soluble polymer (10% solution in water), and the paint mixture of Illustrative Formula 3 is mixed with a water soluble polymer such as Polyox N-80 brand water soluble polymer (25% solution in water) to create the additional illustrative coating mixtures.

Although many different components are suitable for the coating mixture, one example coating utilized Rhoplex AC-19 brand acrylic latex from Rohm and Haas, Tamol 731 brand pigment dispersant from Rohm and Haas, Foamaster NDW defoamer from Henkel, and Triton X165 surfactant from Union Carbide.

When the illustrative coating was coated onto several pieces of a 5 oz/yd², 100% cotton canvas at a rate of about 3 oz/yd² add-on, the resultant coated canvas was tested by a professional watercolor artist and found to be very acceptable as a medium for watercolor painting. The coated canvas accepted the watercolor paints even when the paints were highly diluted with water. The coated canvas also accepted watercolor pencil and allowed the pencil to then be spread via the addition of water.

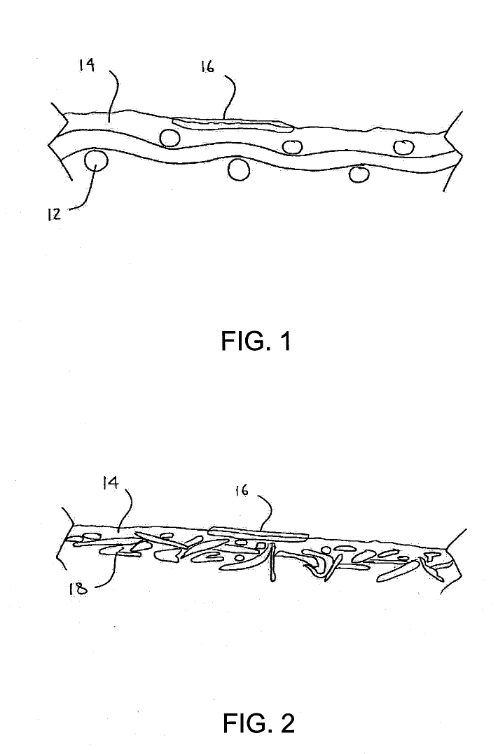

FIGS. 1 and 2 illustrate simplistic sectional side views of the invention. FIG. 1 shows a woven substrate 12, such as a canvas, coated with the coating 14. Watercolor 16 is illustrated painted onto the coating 14. FIG. 2 shows a non-woven substrate 18, such as a felt, coated with the coating 14. Watercolor 16 is illustrated painted onto the coating 14.

The coated canvas worked with dry-brush techniques or could be pre-wetted with water. Further, the coated canvas allowed color to be removed to create effects such as clouds. Additionally, the professional artist demonstrated that the watercolor paints even could be removed by wetting the sample and wiping with a cloth. This allowed the artist to repaint on the same sample, a step that would be impossible with uncoated paper substrates.

The foregoing detailed description of the preferred embodiments and the appended figures have been presented only for illustrative and descriptive purposes and are not intended to be exhaustive or to limit the scope and spirit of the invention. The embodiments were selected and described to best explain the principles of the invention and its practical applications. One of ordinary skill in the art will recognize that many variations can be made to the invention disclosed in this specification without departing from the scope and spirit of the invention.

What is claimed is:

1. An artists canvas comprising a canvas substrate coated with a coating consisting essentially of (a) a paint mixture comprising from 100-200 parts by weight water-based latex, 0-5 parts by weight pigment dispersant, 0-2 parts by weight defoamer, 75-150 parts by weight pigment and colorants, 0-50 parts by weight extender, 0-5 parts by weight surfactant, and 0-50 parts by weight water; and (b) 1-30 weight percent of a water soluble polymer based on the weight of solids in the paint mixture,
wherein the coating accepts watercolor paints, pencils, and inks without unacceptable running or bleeding of the watercolor paints, pencils, and inks in and on the coating and the coating allows for the removal of the watercolor paints, pencils, and inks from the coating without harming the coating by wetting the coating and wiping off the watercolor paints, pencils, and inks.

2. The artists canvas as claimed in claim 1, wherein the canvas substrate is selected from the group consisting of canvas made from natural and synthetic fibers.

3. The artists canvas as claimed in claim 1, wherein the canvas substrate is a flexible canvas selected from the group consisting of cotton and linen canvases.

4. The artists canvas as claimed in claim 1, wherein
the water-based latex selected from the group consisting of acrylic latexes, vinyl latexes, polyvinyl latexes, and mixtures thereof;
the pigment and colorants are selected from the group consisting of titanium dioxide, calcium carbonate, magnesium carbonate, magnesium silicate, clay, inorganic colors, barium sulfate, mica, zinc oxide, zinc dust, metallics, organic colors, silica, other silicates, aluminates, sulphates, carbonates, and mixtures thereof;
the extender is selected from the group consisting of china clay, kaolin clay, talc, silica, whiting, metal stearates, gypsum, mica, barite, blanc fixe, and mixtures thereof; and
the water soluble polymer is selected from the group consisting of polyvinyl alcohol, polyethylene oxide, cellulose and its derivatives, polyvinyl pyrrolidone, starch, animal hide glue, gum Arabic, xanthan gum and guar gum.

5. The artists canvas as claimed in claim 4, wherein the paint mixture comprise 150 parts by weight water-based latex, 2 parts by weight pigment dispersant, 0.8 parts by weight defoamer, 115 parts by weight calcium carbonate, 20 parts by weight talc, 2 parts by weight surfactant, and 30 parts by weight water.

6. An artists canvas comprising a canvas substrate coated with a coating consisting essentially of:
(a) a paint mixture comprising from:
100-200 parts by weight water-based latex selected from the group consisting of acrylic latexes, vinyl latexes, polyvinyl latexes, and mixtures thereof;
0-5 parts by weight pigment dispersant;
0-2 parts by weight defoamer;
75-150 parts by weight pigment and colorants selected from the group consisting of titanium dioxide, calcium carbonate, magnesium carbonate, magnesium silicate, clay, inorganic colors, barium sulfate, mica, zinc oxide, zinc dust, metallics, organic colors, silica, other silicates, aluminates, sulphates, carbonates, and mixtures thereof;
0-50 parts by weight extender selected from the group consisting of china clay, kaolin clay, talc, silica, whiting, metal stearates, gypsum, mica, barite, blanc fixe, and mixtures thereof;
0-5 parts by weight surfactant;
and 0-50 parts by weight water, and
(b) 1-30 weight percent of a water soluble polymer based on the weight of solids in the paint mixture, the water soluble polymer is selected from the group consisting of polyvinyl alcohol, polyethylene oxide, cellulose and its derivatives, polyvinyl pyrrolidone, starch, animal hide glue, gum Arabic, xanthan gum and guar gum,
wherein the canvas substrate is selected from the group consisting of canvas made from natural and synthetic fibers and the coating accepts watercolor paints, pencils, and inks without unacceptable running or bleeding of the watercolor paints, pencils, and inks in and on the coating and the coating allows for the removal of the watercolor paints, pencils, and inks from the coating without harming the coating by wetting the coating and wiping off the watercolor paints, pencils, and inks.

7. An artists panel comprising a coated canvas substrate and stretcher strips, the coated canvas substrate being attached to the stretcher strips, and the coated canvas substrate being coated with a coating consisting essentially of (a) a paint mixture comprising from 100-200 parts by weight water-based latex, 0-5 parts by weight pigment dispersant, 0-2 parts by weight defoamer, 75-150 parts by weight pigment and colorants, 0-50 parts by weight extender, 0-5 parts by weight surfactant, and 0-50 parts by weight water; and (b) 1-30 weight percent of a water soluble polymer based on the weight of solids in the paint mixture,
wherein the coating accepts watercolor paints, pencils, and inks without unacceptable running or bleeding of the watercolor paints, pencils, and inks in and on the coating and the coating allows for the removal of the watercolor paints, pencils, and inks from the coating without harming the coating by wetting the coating and wiping off the watercolor paints, pencils, and inks.

8. The artists panel as claimed in claim 7, wherein the coated canvas substrate comprises a canvas selected from the group consisting of canvas made from natural and synthetic fibers.

9. The artists panel as claimed in claim 8, wherein the canvas is a flexible canvas selected from the group consisting of cotton and linen canvases.

10. The artists canvas as claimed in claim 9, wherein
the water-based latex selected from the group consisting of acrylic latexes, vinyl latexes, polyvinyl latexes, and mixtures thereof;
the pigment and colorants are selected from the group consisting of titanium dioxide, calcium carbonate, magnesium carbonate, magnesium silicate, clay, inorganic colors, barium sulfate, mica, zinc oxide, zinc dust, metallics, organic colors, silica, other silicates, aluminates, sulphates, carbonates, and mixtures thereof;
the extender is selected from the group consisting of china clay, kaolin clay, talc, silica, whiting, metal stearates, gypsum, mica, barite, blanc fixe, and mixtures thereof; and
the water soluble polymer is selected from the group consisting of polyvinyl alcohol, polyethylene oxide, cellulose and its derivatives, polyvinyl pyrrolidone, starch, animal hide glue, gum Arabic, xanthan gum and guar gum.

11. The artists canvas as claimed in claim 10, wherein the paint mixture comprise 150 parts by weight water-based latex, 2 parts by weight pigment dispersant, 0.8 parts by weight defoamer, 115 parts by weight calcium carbonate, 20 parts by weight talc, 2 parts by weight surfactant, and 30 parts by weight water.

12. An artists panel comprising a coated canvas substrate and stretcher strips, the coated canvas substrate being attached to the stretcher strips, and the coated canvas substrate being coated with a coating consisting essentially of:
(a) a paint mixture comprising from:
100-200 parts by weight water-based latex selected from the group consisting of acrylic latexes, vinyl latexes, polyvinyl latexes, and mixtures thereof;
0-5 parts by weight pigment dispersant;
0-2 parts by weight defoamer;
75-150 parts by weight pigment and colorants selected from the group consisting of titanium dioxide, calcium carbonate, magnesium carbonate, magnesium silicate, clay, inorganic colors, barium sulfate, mica, zinc oxide, zinc dust, metallics, organic colors, silica, other silicates, aluminates, sulphates, carbonates, and mixtures thereof;
0-50 parts by weight extender selected from the group consisting of china clay, kaolin clay, talc, silica, whiting, metal stearates, gypsum, mica, barite, blanc fixe, and mixtures thereof;
0-5 parts by weight surfactant; and
0-50 parts by weight water, and
(b) 1-30 weight percent of a water soluble polymer based on the weight of solids in the paint mixture, the water soluble polymer is selected from the group consisting of polyvinyl alcohol, polyethylene oxide, cellulose and its derivatives, polyvinyl pyrrolidone, starch, animal hide glue, gum Arabic, xanthan gum and guar gum,
wherein the canvas substrate is selected from the group consisting of canvas made from natural and synthetic fibers and the coating accepts watercolor paints, pencils, and inks without unacceptable running or bleeding of the watercolor paints, pencils, and inks in and on the coating and the coating allows for the removal of the watercolor paints, pencils, and inks from the coating without harming the coating by wetting the coating and wiping off the watercolor paints, pencils, and inks.
